(19) United States
(12) Patent Application Publication
(10) Pub. No.: US 2011/0286138 A1
(43) Pub. Date: Nov. 24, 2011

(54) Temperature Controller

(75) Inventors: Junda Shi, Yuyao (CN); Huaping Zhang, Yuyao (CN)

(73) Assignee: Junda Shi

(21) Appl. No.: 12/896,826

(22) Filed: Oct. 1, 2010

(30) Foreign Application Priority Data
May 21, 2010 (CN) 201010179904.7

(51) Int. Cl. H02H 3/00

(52) U.S. Cl. 361/86

(57) ABSTRACT

A temperature controller comprises a first power supply input interface and a second power supply input interface for inputting alternating current, a main control module, a temperature safety module and a power conversion module connected between the first power supply input interface and the second power supply input interface; the first input terminal of the main control module is connected with the power conversion module; the second input terminal of the main control module is connected through a power detecting module with the first power supply input interface and the second power supply input interface. The present invention has the advantages of accomplishing conveniently constant temperature control and preventing partial heating elements from high temperature.

### BACKGROUND

1. Field of the Invention

The present invention is related to a temperature controller, especially to the temperature controller applied to controlling the temperature of electric appliances that are used for heating, such as electric blankets.

2. Brief Description of Related Arts

The temperature controller is a widely applied controlling instrument. There is a variety of instruments used for controlling temperature in current marketplace. These instruments mainly adopt a thermistor as a sensor to convert a certain temperature into a corresponding voltage value or current value; then compare the value with a given voltage value or current value, and decide whether or not increase or decrease the temperature with the compared result.

For example, a patent numbered “88209493.9”, entitled “temperature controller”, discloses a temperature controller, which comprises a temperature measuring circuit, a environment temperature compensation circuit, a temperature presetting circuit, a signal compensation and comparison circuit which is coupled with the three circuits mentioned above, and a control circuit which is coupled with the signal compensation and comparison circuit. The temperature measuring circuit includes a temperature sensor for converting the difference of the measured temperature and the environment temperature into an electric signal, and a first amplifying circuit for generating a temperature electric signal. The environment temperature compensation circuit includes a voltage divider network consisting of a normal resistor and a thermal resistor, as a environment temperature converter, and a second amplifying circuit for generating a temperature compensation electric signal. The temperature presetting circuit comprises a voltage divider circuit, which output voltage is adjustable, for generating a preset signal. The signal compensation and comparison circuit has an adder. The control circuit has a relay. In addition, the signal compensation and comparison circuit is coupled with the control circuit through a drive circuit.

However, the temperature of this patent has a complicated structure, and can not fulfill the function of constant temperature control and preventing partial heating elements from high temperature

### SUMMARY OF THE PRESENT INVENTION

The objective of the present invention is to furnish a temperature controller to overcome the shortcomings of the current technology, which can fulfill constant temperature control and prevent partial heating elements from being high temperature.

According to the present invention, the temperature controller comprises a first power supply input interface and a second power supply input interface for inputting AC, and a main control module; a temperature safety module and a power conversion module are connected between the first power supply input interface and the second power supply input interface; the first input terminal of the main control module is connected with the power conversion module, while the second input terminal is connected through a power detecting module with the first power supply interface or the second power supply interface.

To optimize said above technical controller, the following features can be further included.

A branch circuit, which consists of a triac (triode for alternating current), a first resistor and a positive temperature coefficient thermistor, is connected in series between the first power supply input interface and the second power supply input interface. The first input terminal of the main control module is connected with a detecting branch; the other terminal of the detecting branch is connected with the connection point at which the first resistor and the triac are connected. The first power supply input interface or the second power supply input interface is connected in series with a voltage divider branch grounded; the voltage divider branch is connected with a reference voltage branch for detecting the voltage of the power supply; the reference voltage branch is connected with the second input terminal of the main control module; there is a comparator set inside the main control module for comparing the voltage of the first input terminal and the second input terminal.

The above said voltage divider branch consists of a first voltage divider resistor and a second voltage divider resistor. One terminal of the voltage divider branch is connected with the first power supply input interface or the second power supply input interface, and the other terminal is grounded. The second input terminal of the main control module is connected with the connection point at which the first voltage divider resistor and the second voltage divider resistor are connected.

The above said positive temperature coefficient thermistor is provided with negative temperature coefficient insulating materials outside it for overheating protection, wherein the negative temperature coefficient insulating materials are connected with the third input terminal of the main control module.

The above said positive temperature thermistor are heating wires.

The above said main control module is connected with an electric heating element temperature detecting module for detecting the temperature of electric heating elements.

The above said main control module is connected with a time setting module.

The above said main control module is connected with a temperature setting module.

The above said main control module is connected with a display module.

Compared with the existing technology, the temperature controller of the present invention has a temperature safety module and a power conversion module connected between the first power supply input interface and the second power supply input interface. Because the current detection method and the characteristics of the positive temperature thermostat are used to detect the temperature, during the process of heat output, as the temperature of the positive temperature coefficient thermistor goes up, the resistance value of it goes up as well, but contrarily, the output currents go down. The main control module predetermines the absolute value of the decreased current as the temperature that clients desire; therefore, during the process of heating control, once the main control module has detected that the output current has come to the predetermined value, then turn off the output to show the temperature has already met the requirement; after the output is turned off, the temperature of the positive temperature coefficient thermistor will stop increasing, and the heat will be released gradually; wait until the temperature decreases, the control circuit will output heat again. By doing so circularly constant temperature control can be achieved. Besides, the middle insulating layer of the positive temperature coefficient thermistor is the negative temperature coefficient insulating materials, which will lead to decreasing insulating resistance of the negative temperature coefficient insulating materials at high temperatures; therefore by judging the value of the leakage current of the power supply, flowing through the negative temperature coefficient materials, it can be judged that whether or not high temperatures happen to the electric heating elements.

### BRIEF DESCRIPTION OF DRAWINGS

FIG. 1 is the block principle diagram of the temperature controller of the present invention;

FIG. 2 is the partial circuit diagram of FIG. 1;

FIG. 3 is another partial circuit diagram of FIG. 1;

FIG. 4 is one circuit implementation diagram of FIG. 1;

FIG. 5 is one partial diagram of FIG. 4;

FIG. 6 is the other partial diagram of FIG. 4;

FIG. 7 is the second circuit implementation diagram of FIG. 1.

FIG. 8 is one partial diagram of FIG. 7;

FIG. 9 is the other partial diagram of FIG. 7

### DETAILED DESCRIPTION OF THE PREFERRED EMBODIMENTS

In the following detailed description of the embodiments, reference is made to the accompanying drawings, which form a part thereof, and in which are shown by way of illustration specific embodiments in which the disclosure may be practiced.

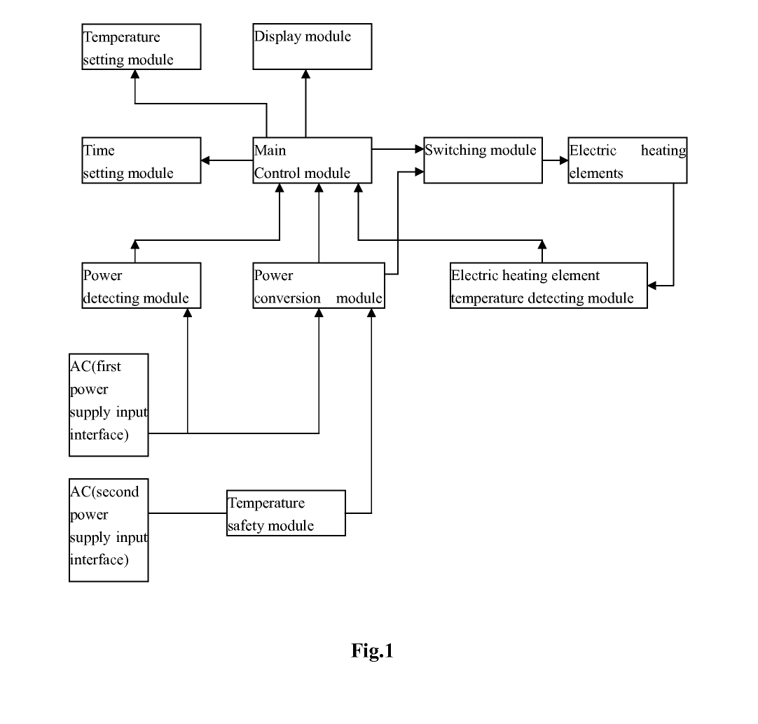

FIG. 1 is the principle diagram of the modules of the present invention. As shown in FIG. 1, the temperature controller comprises a main control module U1, which is connected with a time setting module, a temperature setting module, a display module, and the first power supply input interface and second power supply input interface, which are used for inputting alternating currents. The main control module U1 is connected through a switching module with electric heating elements, and connected with an electric heating element temperature detecting module for detecting the electric heating elements. The main control module U1 is a micro control unit MCU. The first power supply input interface and the second power supply input interface are used to connect the null line and live line.

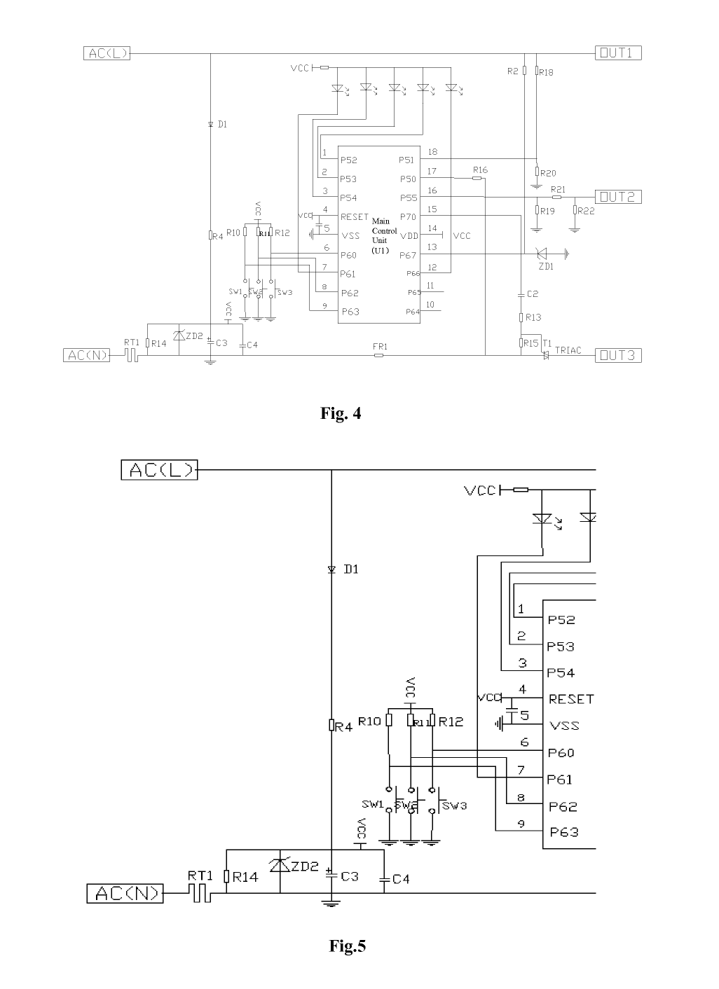

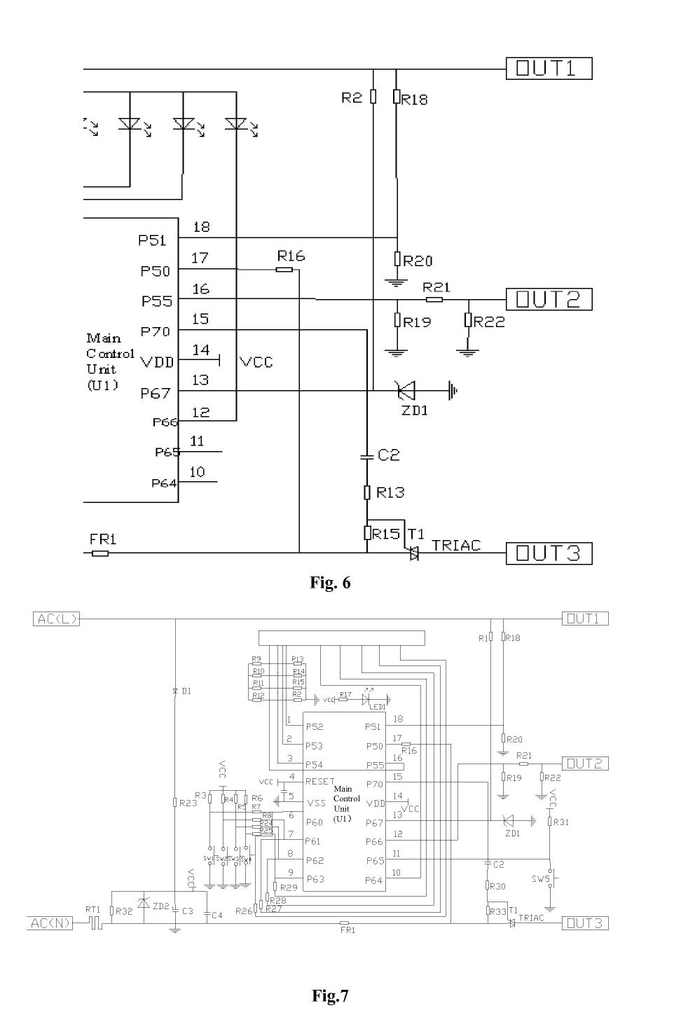

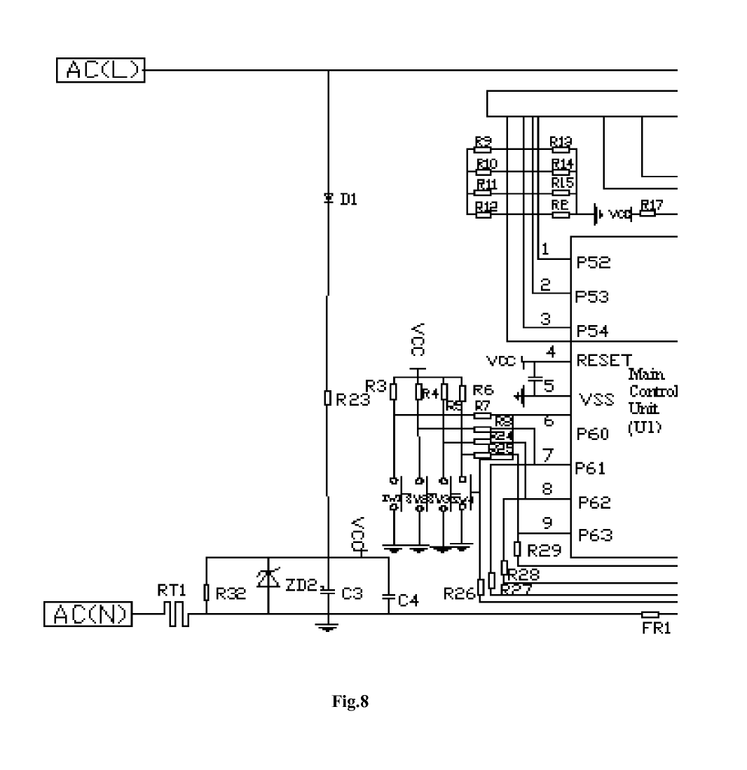

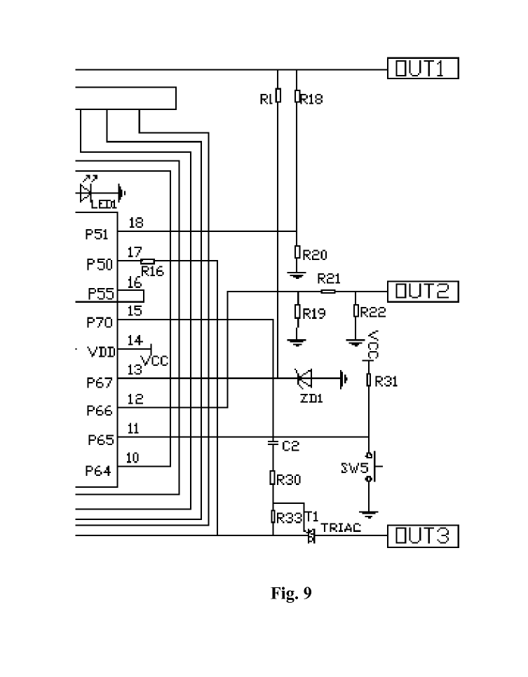

The reason why the present invention has the function of controlling temperature is because a temperature safety module and a power conversion module are connected between the first power supply input interface and the second power input interface. As shown in FIG. 1, FIG. 4 and FIG. 7, the first input terminal P50 of the main control module is connected with the power conversion module, and the second terminal P51 is connected through a power detecting module with the first power supply input interface or the second power supply input interface.

The temperature controller of the present invention adopts the current detecting method to detect temperature. Through applying the characteristics of the positive temperature coefficient thermistor, during the heating process, as the temperature of the positive temperature thermistor goes up, the resistance value of the thermistor goes up, and on the contrary, the output currents decrease. The main control module U1 predetermines the decreased absolute current value as what the clients need; thus, during the heating control, as long as the main control module U1 has detected that the current output comes to the predetermined current value, the heat output would be cut off, which shows the temperature has already met the requirement. After the output is cut off, the temperature of the positive temperature coefficient thermistor will stop increasing, and the temperature will be released out. Wait until the temperature decreases, the control circuit will output heat again. By controlling so circularly the purpose of constant temperature can be achieved. In the present invention, the positive temperature coefficient thermostat uses heating wire, but not limited to it.

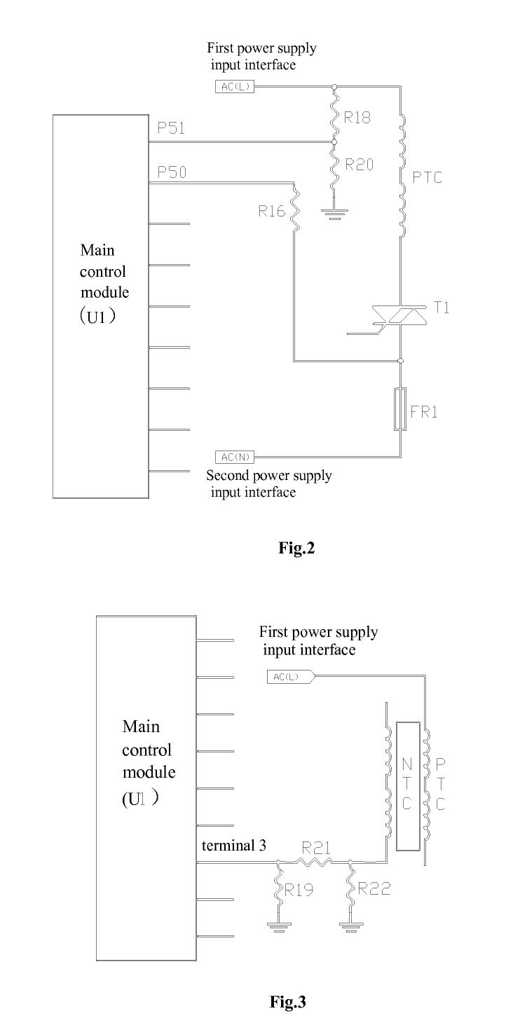

As shown in FIG. 2, there is a branch circuit consisting of a triac T1, a first resistor FR1 and PTC heating wires connected in series between the first power supply input interface and the second power supply input interface; the first resistor FR1 and the triac constitute the temperature safety module. There is a detecting branch for taking a sample of the first resistor FR1 connected at the terminal of the first resistor FR1; as shown in FIG. 4 and FIG. 7, the detecting branch is connected with the first input terminal P50 of the main control module. There is a second resistor R16 connected in series with the detecting branch for preventing overcurrent, which constitutes the power conversion module. The first power supply input interface or the second power supply input interface is connected in series with a voltage divider branch grounded; the voltage divider branch is connected with a reference voltage branch for taking a sample of a reference voltage, the latter being connected with the second input terminal P51 of the main control module. The main control module U1 is provided with a comparator inside for comparing the voltage of the first input terminal P50 and the second input terminal P51.

The voltage divider branch is consisting of a first voltage divider resistor R18 and a second voltage divider resistor R20. The one terminal of the voltage divider branch is connected with the first power supply input interface or the second power supply input interface, and the other terminal grounded. The second input terminal P51 of the main control module is connected with the connection point, at which the first voltage divider resistor and the second voltage divider resistor are connected in series.

Through the PTC heating wires, the TRIAC T1 and the first resistor FR1, the power supply generates load power and accordingly starts heating; the voltage division value generated at the first resistor FR1 is provided through the second resistor R16 to the inside of the main control module U1 so as to detect the voltage. In another path, the power supply also provides the voltage division, which is generated through the first voltage divider resistor R18 and the second voltage divider resistor R20, to the inside of the main control module in order to detect the voltage, and then set the voltage as the reference voltage and the voltage of the first resistor FR1 as the comparison voltage. At the initial state, the comparison voltage is higher than the reference voltage; therefore the main control module U1 keeps heating the PTC heating wires. When the temperature comes to the predetermined value, the voltage at the first resistor FR1 is lower than the reference voltage, which means the temperature is met, then the main control module U1 turns off the triac, so that cut off the load currents, and eventually guarantee the constant temperature.

When the temperature controller is used incorrectly, the phenomena of overheating could occur with partial places or some single point. However, the present invention has the function of preventing the partial heating elements from overheating.

As shown in FIG. 3, the positive temperature coefficient thermistor is provided with negative temperature coefficient insulating materials for overheat protection. The materials NTC are connected with the third input terminal of the main control module.

The insulating layer in the midst of the PTC heating wires is negative temperature coefficient insulating materials NTC which shows the negative temperature coefficient. Under high temperatures, the insulating resistance of the negative temperature coefficient insulating materials NTC decreases; thus, it can be done to judge whether or not the heating elements are overheated by judging the leakage current value of the power supply at the negative temperature coefficient insulating materials. First, switch off the triac, so as to avoid other interference signals or current divider circuits to influence detected results. The following process is as follows: a leakage current circuit is established through the PTC heating elements, the negative temperature coefficient insulating materials NTC, the third resistor R22, the fourth resistor R21, the fifth resistor R19 and the third input terminal of the main control module U1, from the power supply. As long as the potential drop generated because of the leakage currents is as big enough as the high-level threshold voltage of the main control module U1, the main control module will regard that it is a high level, which means the heated object is overheated, and then set the sign of the high temperature as 1. After quitting the detecting procedure, the main control module stops heating until the temperature of the partial area or point that is overheated decreases to the safe range; then start heating again, and do the detection and control circularly, and finally achieve overheat protection.

FIG. 4 is the first implementation circuit diagram of the present invention. FIG. 7 is the second implementation circuit diagram. The implementation circuit will not be limited in FIG. 4 and FIG. 7.

The object of the present invention has been fully and effectively accomplished. Its embodiments have been shown and described for the purpose of illustrating the functional and structural principles of the present invention and is subject to change without departure from such principles. Therefore, this invention includes all modifications encompassed within the spirit and scope of the following claims.

What is claimed is:

1. A temperature controller, comprising
a first power supply input interface and a second power supply input interface for inputting alternating current;
a main control module for detecting temperature and controlling heating;
a temperature safety module for high temperature protection; and
a power conversion module for taking a sample of the voltage of the temperature safety module,
wherein the temperature safety module and the power conversion module are connected between the first power supply input interface and the second power supply input interface;
the first input terminal of the main control module is connected with the power conversion module;
the second input terminal of the main control module is connected with the first power supply input interface and the second power supply input interface, and in turn connected with the temperature safety module.

2. The temperature controller recited in claim 1, wherein the temperature safety module comprises a triac and a first resistor, wherein the triac and the first resistor and a positive temperature coefficient thermistor are connected in series, so as to constitute a branch circuit between the first power supply input interface and the second power supply input interface;
the power conversion module is a detecting branch with one terminal connected with the first input terminal of the main control module and the second terminal connected with the connection point at which the first resistor and the triac are connected.

3. The temperature controller recited in claim 2, the second input terminal of the main control module is connected through a power detecting module with the first power supply input interface and the second power supply input interface.

4. The temperature controller recited in claim 3, wherein the power detecting module is a grounded voltage divider branch connected in series with the first power supply input interface or the second power supply input interface;

5. The temperature controller recited in claim 4, wherein the voltage divider branch is connected with a reference voltage branch of detecting the voltage of the power; the reference voltage branch is connected with the second input terminal of the main control module; there is a comparator set inside the main control module for comparing the voltage of the first input terminal and the second input terminal.

6. The temperature controller recited in claim 5, wherein the voltage divider branch consists of a first voltage divider resistor and a second voltage divider resistor; one terminal of the voltage divider branch is connected with the first power supply input interface or the second power supply input interface, and the other terminal is grounded; the second input terminal of the main control module is connected with the connection point at which the first voltage divider resistor and the second voltage divider resistor are connected.

7. The temperature controller recited in claim 2, wherein the positive temperature coefficient thermistor is provided with negative temperature coefficient insolating materials outside it for overheating protection; the negative temperature coefficient insulating materials are connected with the third input terminal of the main control module.

5. The temperature controller recited in claim 7, wherein the positive temperature coefficient thermistor is PTC heating wires.

6. The temperature controller recited in claim 1, wherein the main control module is connected with an electric heating element detecting module for detecting the electric heating elements.

7. The temperature controller recited in claim 1, wherein the main control module is connected with a time setting module.

8. The temperature controller recited in claim 1, wherein the main control module is connected with a temperature setting module.

9. The temperature controller recited in claim 1, wherein the main control module is connected with a display module.
